(19) United States
(12) Patent Application Publication
(10) Pub. No.: US 2024/0387856 A1
(43) Pub. Date: Nov. 21, 2024

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/607,734

(22) Filed: Mar. 18, 2024

(30) Foreign Application Priority Data
May 17, 2023 (JP) 2023-081734

(51) Int. Cl. H01M 10/04; H01M 4/04

(52) U.S. Cl. CPC H01M 10/0431; H01M 4/0404

(57) ABSTRACT

A power storage cell includes a wound electrode assembly which includes: a positive plate (a first electrode); a negative plate (a second electrode); and a separator. The positive plate includes a positive current collector (a first current collector) and a positive electrode mixture layer (a first electrode material layer). The positive uncoated portion of the positive current collector is not coated with the positive electrode mixture layer and is bent in the radial direction of the wound electrode assembly. The positive uncoated portion includes a portion (a first portion) a portion (a first proximate portion) which are joined together by welding, the portion projecting from the positive coated portion at a location more proximate to a winding axis than a location at which the portion projects from the positive coated portion.

### CROSS REFERENCE TO RELATED APPLICATIONS

This nonprovisional application is based on Japanese Patent Application No. 2023-081734 filed on May 17, 2023 with the Japan Patent Office, the entire content of which is hereby incorporated by reference.

### BACKGROUND OF THE DISCLOSURE

### Field of the Disclosure

The present disclosure relates to a power storage cell.

### Description of the Background Art

Japanese Patent No. 4805545 discloses a lithium secondary battery that includes a wound internal electrode assembly which includes a positive metallic foil and a negative metallic foil with a separator in between. The internal electrode assembly is a tabless electrode which includes end portions of the metallic foils (positive, negative) in contact with current collector members (positive, negative). The internal electrode assembly is accommodated in a case.

### SUMMARY OF THE DISCLOSURE

While not described explicitly in Japanese Patent No. 4805545, a tape for securing the internal electrode assembly may be applied to the side surface of the internal electrode assembly in order to maintain the internal electrode assembly in the wound state. Here, in order to restrict the movement of the internal electrode assembly, the space between the side surface of the internal electrode assembly and the inner circumferential surface of the case is small. Due to this, the tape and the case interfere as the internal electrode assembly expands or the like, producing a local pressure at the internal electrode assembly where the tape is applied.

The present disclosure is made to solve the above problem, and an object of the present disclosure is to provide a power storage cell that can maintain the wound electrode assembly in the wound state, while inhibiting a local pressure from being produced at the wound electrode assembly.

A power storage cell according to one aspect of the present disclosure includes: a wound electrode assembly which includes a first electrode, a second electrode, and a separator disposed between the first electrode and the second electrode; and a case accommodating the wound electrode assembly. The wound electrode assembly is configured of the first electrode, the second electrode, and the separator being wound about a winding axis. The first electrode includes a first current collector and a first electrode material layer with which a portion of the first current collector is coated, the first electrode material layer facing the separator in a radial direction of the wound electrode assembly. The first current collector has: a first coated portion that is coated with the first electrode material layer; and a first uncoated portion that is not coated with the first electrode material layer, the first uncoated portion projecting from the first coated portion to one axial side of the wound electrode assembly. The first uncoated portion is bent in the radial direction, and the first uncoated portion includes a first portion and a first proximate portion which are joined together by welding, wherein the first proximate portion projects from the first coated portion at a location more proximate to the winding axis than a location at which the first portion projects from the first coated portion.

In the power storage cell according to the aspect of the present disclosure, the first portion of the first uncoated portion and the first proximate portion of the first uncoated portion, located more proximate to the winding axis than the first portion is, are joined together by welding, as described above. This can restrict the wound electrode assembly from being unwound, taking advantage of the joining force of welding of the first portion and the first proximate portion. As a result, the wound electrode assembly can be maintained in the wound state without having to apply a tape to the side surface of the wound electrode assembly. This can maintain the wound electrode assembly in the wound state, while inhibiting a local pressure from being produced at the wound electrode assembly caused by the application of a tape.

In the power storage cell according to the aspect, preferably, a welded portion, which is formed by the first portion and the first proximate portion being welded together, is formed in a portion on the one axial side of the wound electrode assembly. With this configuration, when an electrolyte solution is injected into the wound electrode assembly from the one axial side, the flow of the electrolyte solution can be better prevented from being blocked by the welded portion than the case where the welded portion is formed across (the entirety of) the wound electrode assembly.

In this case, the welded portion is formed at least in the first portion on the outer periphery of the wound electrode assembly. With this configuration, the wound electrode assembly can be inhibited from being brought out of the wound state, starting from the outer periphery side thereof.

In the power storage cell in which the welded portion includes the first portion on the outer periphery, preferably, the wound electrode assembly includes a termination portion where winding of the wound electrode assembly terminates. The welded portion is formed at least in the first portion on the termination portion. With this configuration, the wound electrode assembly can be inhibited from being brought out of the wound state, starting from the termination portion, thereby readily maintaining the wound electrode assembly in the wound state.

In the power storage cell in which the welded portion is formed in the first portion on the outer periphery, preferably, the welded portion extends from the first portion on the outer periphery to the first proximate portion on the inner periphery of the wound electrode assembly. With this configuration, the welded portion can be readily elongated, thereby readily maintaining the wound electrode assembly in the wound state.

In the power storage cell according to the aspect, preferably, the second electrode includes a second current collector and a second electrode material layer with which a portion of the second current collector is coated, the second electrode material layer facing the separator in the radial direction. The second current collector has: a second coated portion that is coated with the second electrode material layer; and a second uncoated portion that is not coated with the second electrode material layer, the second uncoated portion projecting from the second coated portion to the other axial side of the wound electrode assembly. The second uncoated portion is bent in the radial direction. The second uncoated portion includes a second portion and a second proximate portion which are joined together by welding, wherein the second proximate portion projects from the second coated portion at a location more proximate to the winding axis than a location at which the second portion projects from the second coated portion. With this configuration, the wound electrode assembly can be maintained in the wound state, taking advantage of the joining force of welding of the second portion and the second proximate portion too. This more ensures that the wound electrode assembly is maintained in the wound state.

According to the present disclosure, the wound electrode assembly is maintained in the wound state, while inhibiting a local pressure from being produced at the wound electrode assembly.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view showing a configuration of a power storage cell according to an embodiment.

FIG. 2 is a perspective view showing a configuration of a wound electrode assembly according to the embodiment.

FIG. 3 is an enlarged partial view of the positive side of the power storage cell of FIG. 1.

FIG. 4 is an enlarged partial view of the negative side of the power storage cell of FIG. 1.

FIG. 5 is a plan view of the wound electrode assembly according to the embodiment, as viewed from Z1 side.

FIG. 6 is a schematic cross-sectional view showing a method of formation of a welded portion of the wound electrode assembly according to the embodiment.

FIG. 7 is a side view of the wound electrode assembly according to the embodiment, as viewed from radially outside.

FIG. 8 is a plan view of the wound electrode assembly according to the embodiment, as viewed from Z2 side.

FIG. 9 is a plan view of the wound electrode assembly according to Variation 1 of the embodiment, as viewed from Z1 side.

FIG. 10 is a plan view of the wound electrode assembly according to Variation 2 of the embodiment, as viewed from Z1 side.

FIG. 11 is a plan view of the wound electrode assembly according to Variation 3 of the embodiment, as viewed from Z1 side.

FIG. 12 is a plan view of the wound electrode assembly according to Variation 4 of the embodiment, as viewed from Z1 side.

FIG. 13 is a plan view of the wound electrode assembly according to Variation 5 of the embodiment, as viewed from Z1 side.

FIG. 14 is a cross-sectional view of the wound electrode assembly, taken along XIV-XIV line of FIG. 13.

FIG. 15 is a side view of the wound electrode assembly according to Variation 6 of the embodiment, as viewed from radially outside.

### DESCRIPTION OF THE PREFERRED EMBODIMENTS

Hereinafter, an embodiment according to the present disclosure will be described, with reference to the accompanying drawings. Note that like reference signs are used to refer to like or corresponding parts in the drawings, and the description thereof will not be repeated.

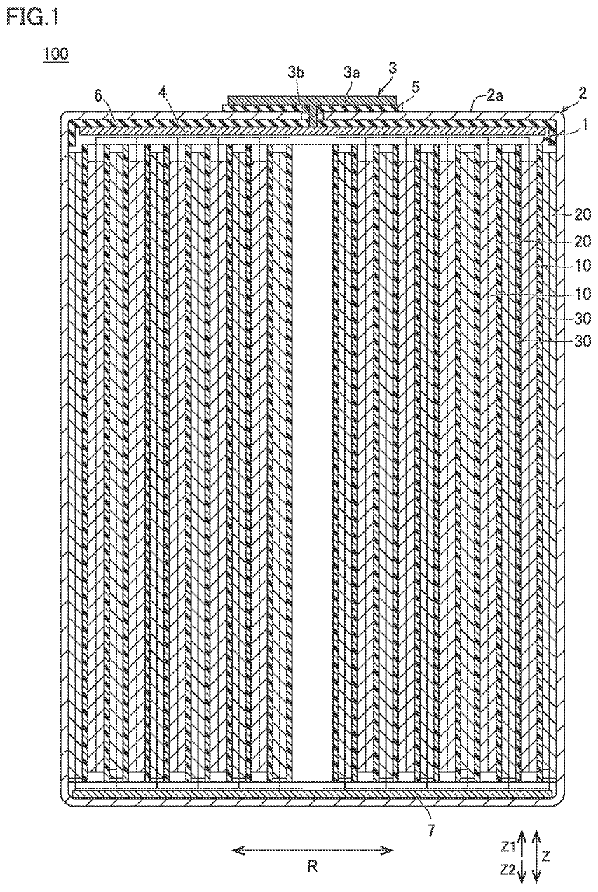

FIG. 1 is a cross-sectional view showing a general configuration of a power storage cell 100 according to an embodiment of the present disclosure. The power storage cell 100 is, for example, a lithium-ion battery that is mounted on a vehicle. Note that the application and type of the power storage cell 100 are not limited thereto.

The power storage cell 100 includes a wound electrode assembly 1, a case 2, a positive terminal 3, a positive current collector plate 4, an external gasket 5, an internal gasket 6, and a negative current collector plate 7.

The wound electrode assembly 1 is accommodated in the case 2. The case 2 has a cylindrical shape. In other words, the power storage cell 100 is a cylindrical battery. Note that the case 2 is formed of copper or aluminum, for example.

The wound electrode assembly 1 includes positive plates 10, negative plates 20, and separators 30. The separator 30 is disposed between the positive plate 10 and the negative plate 20. The separator 30 separates the positive plate 10 and the negative plate 20, while allowing ions (e.g., lithium-ions) to traverse between the positive plate 10 (a positive active material) and the negative plate 20 (a negative active material). The wound electrode assembly 1 is configured of a group of electrode plates in which the positive plate 10 and the negative plate 20 are wound via the separator 30. Note that the positive plate 10 and the negative plate 20 are one example of a “first electrode” and a “second electrode,” respectively, according to the present disclosure.

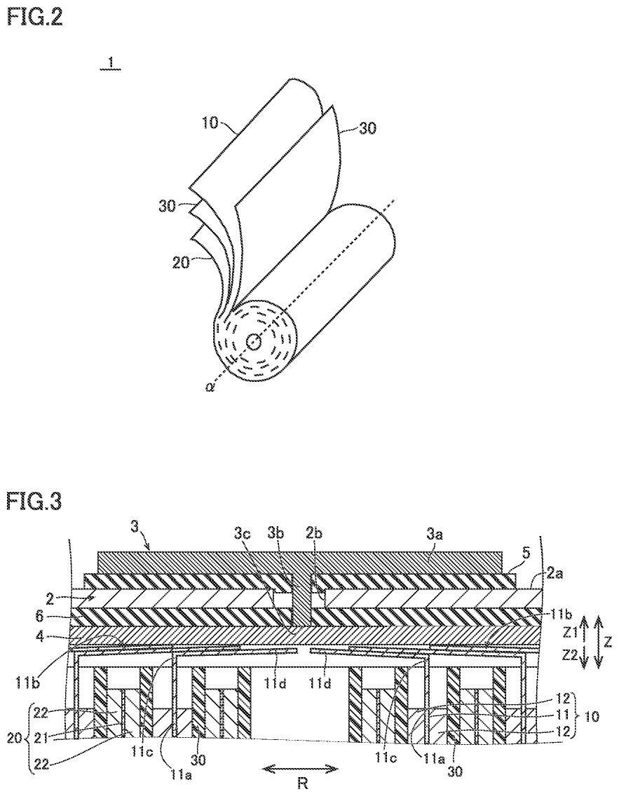

As shown in FIG. 2, the wound electrode assembly 1 configured of the positive plate 10, the negative plate 20, and the separator 30 being wound about a winding axis α of the wound electrode assembly 1.

Referring, again, to FIG. 1, the positive terminal 3 includes a disk portion 3a and a riveting portion 3b. The riveting portion 3b is connected to the disk portion 3a. The riveting portion 3b extends from the center of the disk portion 3a to Z2 side. Note that the positive terminal 3 is formed of aluminum.

As shown in FIG. 3, the disk portion 3a is disposed on an upper surface 2a (the Z1-side surface) of the case 2. The upper surface 2a of the case 2 has a through hole 2b. The riveting portion 3b extends from the disk portion 3a, disposed outside the case 2, into the case 2 through the through hole 2b.

The positive current collector plate 4 is accommodated in the case 2. On Z1 side of the wound electrode assembly 1, the positive current collector plate 4 is welded to a positive uncoated portion 11b (described below) of the positive plate 10. This causes the positive current collector plate 4 to be positively charged. The positive current collector plate 4 is welded to an end 3c of the riveting portion 3b on Z2 side. This causes the positive terminal 3 to be positively charged.

The external gasket 5 is disposed between the disk portion 3a of the positive terminal 3 and the upper surface 2a of the case 2. This electrically insulates the positive terminal 3 from the case 2.

The internal gasket 6 is disposed in the case 2 between the case 2 and the positive current collector plate 4. This electrically insulates the case 2 from the positive current collector plate 4. Note that the riveting portion 3b passes through the internal gasket 6 and is thereby in contact with the positive current collector plate 4.

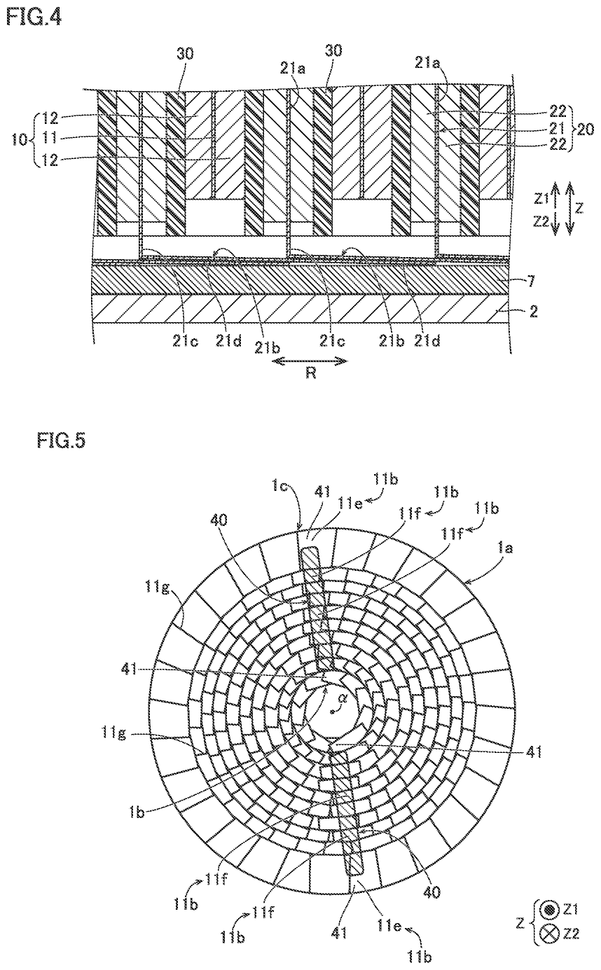

As shown in FIG. 4, the negative current collector plate 7 is accommodated in the case 2. On Z2 side of the wound electrode assembly 1, the negative current collector plate 7 is welded to a negative uncoated portion 21b of the negative plate 20 described below. This causes the negative current collector plate 7 to be negatively charged. Note that the negative current collector plate 7 is in contact with the case 2. This causes the case 2 to be negatively charged.

Referring, again, to FIG. 3, the positive plate 10 includes a positive current collector 11 and a positive electrode mixture layer 12. The positive electrode mixture layer 12 is applied to radially (R direction) opposite surfaces of the positive current collector 11 (a positive coated portion 11a described below). The positive electrode mixture layer 12 faces the separator 30 in R direction. Note that the positive current collector 11 and the positive electrode mixture layer 12 are one example of a “first current collector” and a “first electrode material layer,” respectively, according to the present disclosure.

For example, aluminum is used for the positive current collector 11. The positive electrode mixture layer 12 is formed by coating a surface of the positive current collector 11 with a cathode slurry and drying. The cathode slurry is prepared by mixing the materials (such as a positive active material and a binder) of the positive electrode mixture layer 12 and a solvent. The positive electrode mixture layer 12 is appressed to the separator 30 (see FIG. 1). The positive electrode mixture layer 12 has a thickness greater than or equal to 0.1 μm and less than or equal to 1000 μm, for example.

The positive current collector 11 includes a positive coated portion 11a and a positive uncoated portion 11b. The positive coated portion 11a is a portion of the positive current collector 11 that is coated with the positive electrode mixture layer 12. The positive coated portion 11a is sandwiched between the separators 30. Note that the positive coated portion 11a and the positive uncoated portion 11b are one example of a “first coated portion” and a “first uncoated portion,” respectively, according to the present disclosure.

The positive uncoated portion 11b is a portion of the positive current collector 11 that is not coated with the positive electrode mixture layer 12. The positive uncoated portion 11b is located more to Z1 side than the positive coated portion 11a is. Specifically, the positive uncoated portion 11b projects from the positive coated portion 11a to Z1 side. Note that Z1 side is one example of a “one axial side” according to the present disclosure.

The positive uncoated portion 11b includes a portion 11c extending along Z direction and a portion 11d extending along R direction. The positive uncoated portion 11b is bent radially inward. The positive uncoated portion 11b is bent in an L shape. The portion 11d of the positive uncoated portion 11b is in contact with the positive current collector plate 4. This causes the positive current collector plate 4 to be positively charged. Note that the positive uncoated portion 11b (the portion 11d) is joined to the positive current collector plate 4 by welding.

Multiple positive uncoated portions 11b are aligned in the winding direction. A slit 11g (see FIG. 5) is formed between the positive uncoated portions 11b that are adjacent to each other in the winding direction. Among the positive uncoated portion 11b, the positive uncoated portions 11b that are adjacent to each other in R direction partially overlap.

Referring, again, to FIG. 4, the negative plate 20 includes a negative current collector 21 and a negative electrode mixture layer 22. The negative electrode mixture layer 22 is applied to radially (R direction) opposite surfaces of the negative current collector 21 (a negative coated portion 21a described below). The negative electrode mixture layer 22 faces the separator 30 in R direction. Note that the negative current collector 21 and the negative electrode mixture layer 22 are one example of a “second current collector” and a “second electrode material layer,” respectively, according to the present disclosure.

For example, copper is used for the negative current collector 21. The negative electrode mixture layer 22 is formed by coating a surface of the negative current collector 21 with an anode slurry and drying. The anode slurry is prepared by mixing the materials (such as a negative active material and a binder) of the negative electrode mixture layer 22 and a solvent. The negative electrode mixture layer 22 is appressed to the separator 30. The negative electrode mixture layer 22 has a thickness greater than or equal to 0.1 μm and less than or equal to 1000 μm, for example.

The negative current collector 21 includes a negative coated portion 21a and a negative uncoated portion 21b. The negative coated portion 21a is a portion of the negative current collector 21 that is coated with the negative electrode mixture layer 22. The negative coated portion 21a is sandwiched between the separators 30. Note that the negative coated portion 21a and the negative uncoated portion 21b are one example of a “second coated portion” and a “second uncoated portion,” respectively, according to the present disclosure.

The negative uncoated portion 21b is a portion of the negative current collector 21 that is not coated with the negative electrode mixture layer 22. The negative uncoated portion 21b is located more to Z2 side than the negative coated portion 21a is. Specifically, the negative uncoated portion 21b projects from the negative coated portion 21a to Z2 side. Note that Z2 side is one example of “the other axial side” according to the present disclosure.

The negative uncoated portion 21b includes a portion 21c extending along Z direction and a portion 21d extending along R direction. The negative uncoated portion 21b is bent radially inward. The negative uncoated portion 21b is bent in an L shape. The portion 21d of the negative uncoated portion 21b is in contact with the negative current collector plate 7. This causes the negative current collector plate 7 to be negatively charged. Note that the negative uncoated portion 21b (the portion 21d) is joined to the negative current collector plate 7 by welding.

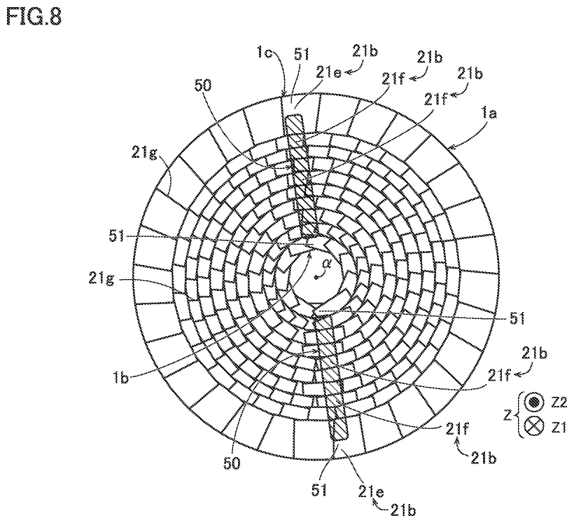

Multiple negative uncoated portions 21b are aligned along the winding direction. A slit 21g (see FIG. 8) is formed between the negative uncoated portions 21b that are adjacent to each other in the winding direction. Among the negative uncoated portion 21b, the negative uncoated portions 21b that are adjacent to each other in R direction partially overlap.

Here, with a configuration of a conventional power storage cell, a tape for securing a wound electrode assembly may be applied to the side surface of the wound electrode assembly in order to maintain the wound electrode assembly in the wound state. In this case, as the wound electrode assembly expands or the like, a local pressure may be produced at the wound electrode assembly where the tape is applied.

Thus, in the present embodiment, a portion 11e, which is one of the positive uncoated portions 11b, and a portion 11f, which is one of the positive uncoated portions 11b, are joined together by welding, as shown in FIG. 5. FIG. 5 is a plan view of the wound electrode assembly 1, as viewed from Z1 side. The portions 11f are located more proximate to the winding axis α than the portion 11e is, and project from the positive coated portions 11a. In other words, the portion 11f projects from the positive coated portion 11a at a location more proximate to the winding axis α than a location at which the portion 11e projects from the positive coated portion 11a. Welding the portions 11e and the portions 11f form welded portions 40 (the hatched portions of FIG. 5). Note that the portion 11e and the portion 11f are one example of a “first portion” and a “first proximate portion,” respectively, according to the present disclosure.

The portion 11e is the positive uncoated portion 11b that is disposed on the outer periphery (the radially outermost edge) 1a of the wound electrode assembly 1. In other words, the portion 11e is the positive uncoated portion 11b of the positive current collector 11 that is projecting, to Z1 side, from the positive coated portion 11a (see FIG. 3) that is wound on the radially outermost side of the wound electrode assembly 1. Accordingly, the welded portion 40 is formed at least in the portion 11e on the outer periphery 1a.

The portion 11f is the positive uncoated portion 11b that is projecting, to Z1 side, from the positive coated portion 11a that is wound radially inward than the positive coated portion 11a that is wound on the radially outermost side of the wound electrode assembly 1.

The portion 11f is provided radially inward than the portion 11e is. Multiple portions 11f are arranged along the radial direction on the radially inner side of the portion 11e. In other words, the portion 11e and the portions 11f are aligned along the radial direction.

The portion 11e and the portion 11f partially overlap in Z direction. The portions 11f that are adjacent to each other in the radial direction partially overlap in Z direction. The welded portion 40 is formed of the positive uncoated portions 11b (the portion 11e and the portion 11f/adjacent portions 11f), which overlap in Z direction, being welded together. No welded portion 40 is formed in the vicinity of the outer periphery 1a of the wound electrode assembly 1 where the positive uncoated portions 11b do not partially overlap, and in the vicinity of the inner periphery 1b (the radially innermost edge). Accordingly, an unwelded portion 41 is provided between the welded portion 40 and the outer periphery 1a and between the welded portion 40 and the inner periphery 1b.

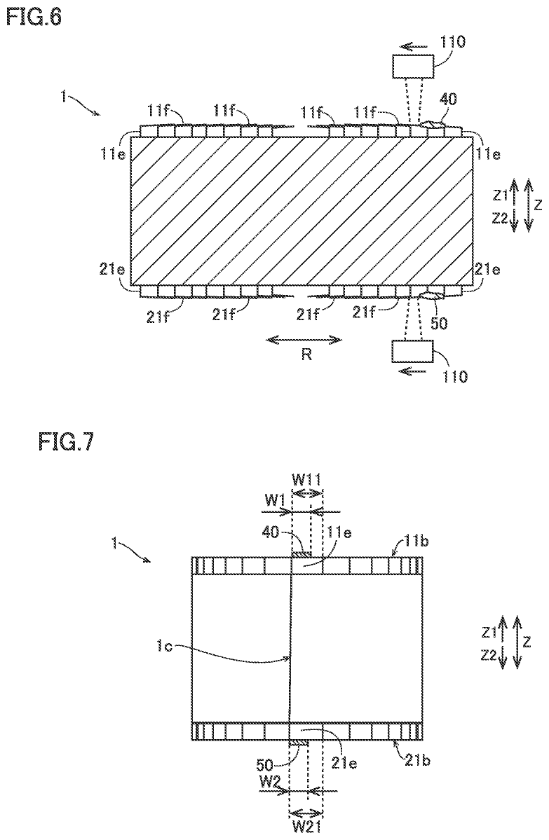

The welded portion 40 is formed extending linearly along the radial direction. For example, the welded portion 40 (and a welded portion 50 described below) is formed by a laser irradiator 110 (see FIG. 6) irradiating the wound electrode assembly 1 with laser, while scanning over the wound electrode assembly 1 on Z1 side in the radial direction (R direction). The welded portion 40 (50) is formed by lap joint welding using the laser irradiator 110.

The welded portion 40, as viewed from Z1 side, extends from the portion 11e on the outer periphery 1a of the wound electrode assembly 1 to the portion 11f on the inner periphery 1b of the wound electrode assembly 1. In other words, the welded portion 40 is formed from the vicinity of the outer periphery 1a to the vicinity of the inner periphery 1b.

In the example shown in FIG. 5, two welded portions 40 are formed. The welded portions 40 are provided on the opposite sides about the winding axis α. In other words, the two welded portion 40 lie on a straight line passing through the winding axis α. This enables the two welded portions 40 to be formed sequentially, without changing the scanning direction of the laser irradiator 110 (see FIG. 6). Note that one or three or more welded portions 40 may be formed.

As can be understood from the above description, the welded portions 40, as viewed from Z1 side, are provided at portions of the wound electrode assembly 1. Specifically, the welded portions 40, as viewed from Z1 side, are formed in a portion of the area occupied by the positive uncoated portions 11b.

FIG. 7 is a side view of the wound electrode assembly 1, as viewed from radially outside the portion 11e. As shown in FIG. 7, the wound electrode assembly 1 includes a wound termination portion 1c. The portion 11e having one of the two welded portions 40 formed therein is disposed on the termination portion 1c. Accordingly, the welded portion 40 is formed at least in the portion 11e on the termination portion 1c. Note that the welded portion 40 being provided at the termination portion 1c includes not only the welded portion 40 as being provided, overlapping the termination portion 1c in the circumferential direction, but also the welded portion 40 as being provided in the vicinity of the termination portion 1c in the circumferential direction.

The negative side of the power storage cell 100 is configured in the same manner as the positive side thereof. Specifically, a portion 21e, which is one of the negative uncoated portions 21b, and a portion 21f, which is one of the negative uncoated portions 21b, are joined together by welding, as shown in FIG. 8. FIG. 8 is a plan view of the wound electrode assembly 1, as viewed from Z2 side. The portions 21f are located more proximate to the winding axis α than the portion 21e is, and project from the negative coated portions 21a. In other words, the portion 21f projects from the negative coated portion 21a at a location more proximate to the winding axis α than a location at which the portion 21e projects from the negative coated portion 21a. Welding the portions 21e and the portions 21f form welded portions 50 (the hatched portions of FIG. 8). Note that the portion 21e and the portion 21f are one example of a “second portion” and a “second proximate portion,” respectively, according to the present disclosure.

The portion 21e is disposed on the outer periphery 1a of the wound electrode assembly 1. In other words, the portion 21e is the negative uncoated portion 21b of the negative current collector 21 that is projecting, to Z2 side, from the negative coated portion 21a (see FIG. 4) that is wound on the radially outermost side of the wound electrode assembly 1. Accordingly, the welded portion 50 is formed at least in the portion 21e on the outer periphery 1a.

The portion 21f is the negative uncoated portion 21b that is projecting, to Z2 side, from the negative coated portion 21a that is wound radially inward than the negative coated portion 21a that is wound on the radially outermost side of the wound electrode assembly 1.

The portion 21f is provided radially inward than the portion 21e. Multiple portions 21f are arranged along the radial direction on the radially inner side of the portion 21e. In other words, the portion 21e and the portions 21f are aligned along the radial direction.

The portion 21e and the portion 21f partially overlap in Z direction. The portions 21f that are adjacent to each other in the radial direction partially overlap in Z direction. The welded portion 50 is formed of the negative uncoated portions 21b (the portion 21e and the portion 21f/adjacent portions 21f), which overlap in Z direction, being welded together. No welded portion 50 is formed in the vicinity of the outer periphery 1a of the wound electrode assembly 1 where the positive uncoated portions 21b do not partially overlap, and in the vicinity of the inner periphery 1b. Accordingly, an unwelded portion 51 is provided between the welded portion 50 and the outer periphery 1a and between the welded portion 50 and the inner periphery 1b.

As can be understood from the above description, the welded portions 50, as viewed from Z2 side, are provided at portions of the wound electrode assembly 1. Specifically, the welded portions 50, as viewed from Z2 side, are formed in a portion of the area occupied by the negative uncoated portions 21b. Note that the welded portion 50 may be formed in an area where it overlaps the welded portion 40 in Z direction (an area corresponding to the welded portion 40 in plan view).

Referring, again, to FIG. 7, the portion 21e having one of the two welded portions 50 formed therein is disposed on the termination portion 1c. Note that the welded portion 50 being provided at the termination portion 1c includes not only the welded portion 50 as being provided, overlapping the termination portion 1c in the circumferential direction, but also the welded portion 50 as being provided in the vicinity of the termination portion 1c in the circumferential direction. This enables restricting, from both Z1 side and Z2 side, the wound electrode assembly 1 from being unwound, starting from the termination portion 1c.

As shown in FIG. 7, the welded portion 40 has a width W1 in the circumferential direction that is less than a width W11 of the positive uncoated portion 11b in the circumferential direction. The welded portion 50 has a width W2 in the circumferential direction less than a width W21 of the negative uncoated portion 21b in the circumferential direction. This enables a reduced area for the welded portion 40 (50), thereby inhibiting the electrolyte solution from being blocked by the welded portion 40 (50). Note that the width W1 of the welded portion 40 may be greater than or equal to the width W11 of the positive uncoated portion 11b. The width W2 of the welded portion 50 may be greater than or equal to the width W21 of the negative uncoated portion 21b.

As described above, in the present embodiment, the portion 11e, which is a portion of the positive uncoated portion 11b, and the portions 11f, which project from the positive coated portions 11a at the locations more proximate to the winding axis α than the portion 11e is, are joined together by welding. As the portion 11e is joined to the portions 11f, the portion 11e is restricted from being separated from the portions 11f. As a result, the wound electrode assembly 1 can be maintained in the wound state in a stable manner. This can obviate the need for a tape for maintaining the wound electrode assembly 1 in the wound state. As a result, the wound electrode assembly 1 can be maintained in the wound state while inhibiting a local pressure from being produced at the wound electrode assembly 1.

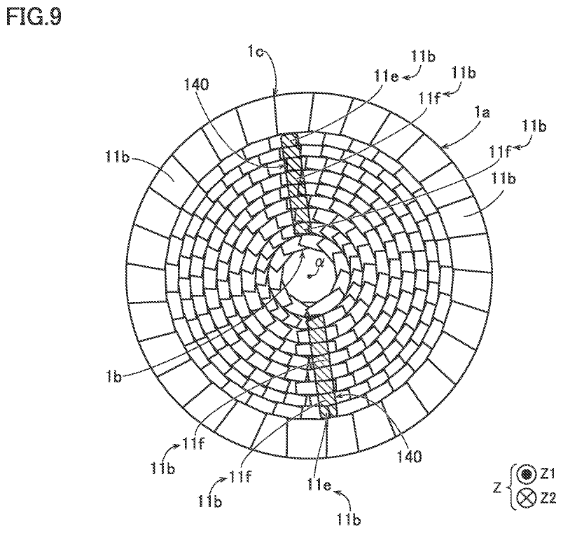

In the above embodiment, the welded portion 40 (50) is formed in the portion 11e (21e) on the outer periphery 1a of the wound electrode assembly 1. However, the present disclosure is not limited thereto. The welded portion 40 (50) may not be formed in the uncoated portion (11b, 21b) on the outer periphery 1a. For example, in the example shown in FIG. 9, the portions 11e are the positive uncoated portions 11b that are provided radially inward than the positive uncoated portions 11b on the outer periphery 1a. In other words, the welded portions 140, shown in FIG. 9, are not formed in the positive uncoated portions 11b on the outer periphery 1a. The negative side of the power storage cell 100 may also be configured in the same manner.

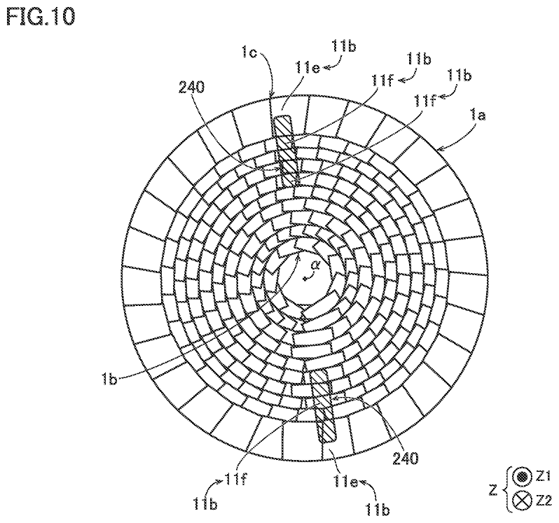

In the above embodiment, the welded portion 40 (50) extends from the vicinity of the outer periphery 1a to the vicinity of the inner periphery 1b. However, the present disclosure is not limited thereto. The welded portion 40 (50) may not extend to the vicinity of the inner periphery 1b. For example, in the example shown in FIG. 10, the welded portion 240 extends from the vicinity of the outer periphery 1a to the middle between the outer periphery 1a and the inner periphery 1b. Note that the negative side of the power storage cell 100 may also be configured in the same manner.

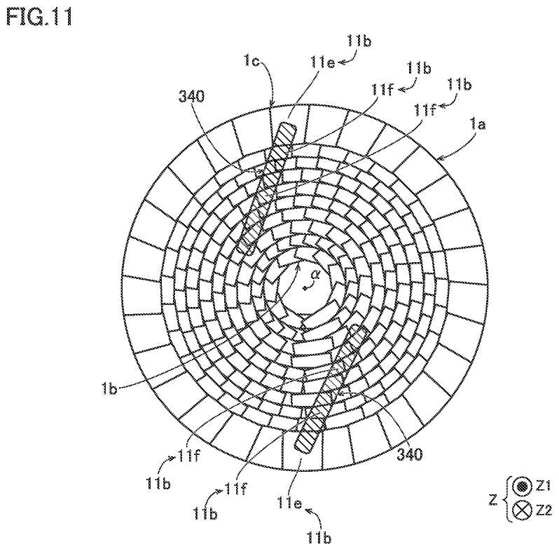

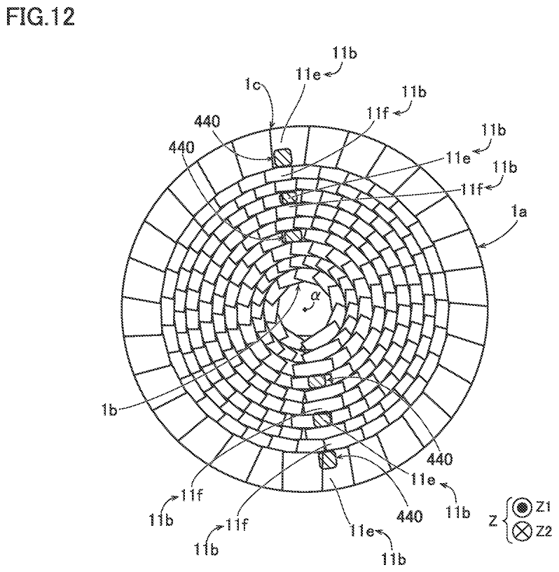

In the above embodiment, the welded portion 40 (50) extends in the radial direction. However, the present disclosure is not limited thereto. The welded portion 40 (50) may not extend in the radial direction. For example, in the example shown in FIG. 11, the welded portion 340 extends in a direction intersecting with the radial direction and the circumferential direction. Note that the negative side of the power storage cell 100 may also be configured in the same manner.

In the above embodiment, the welded portion 40 (50) is formed extending linearly in the radial direction. However, the present disclosure is not limited thereto. The welded portion 40 (50) may not be formed linearly. For example, in the example shown in FIG. 12, multiple welded portions 440, each formed by the portion 11e and the portion 11f being weld together, are formed spaced apart from each other. The welded portions 440 are aligned along the radial direction. Note that the welded portions 440 may not align in the radial direction. The negative side of the power storage cell 100 may also be configured in the same manner.

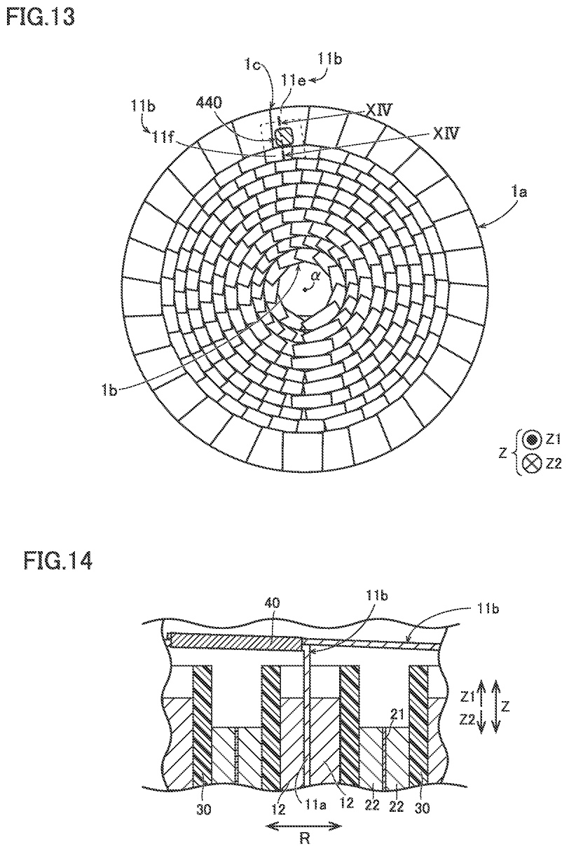

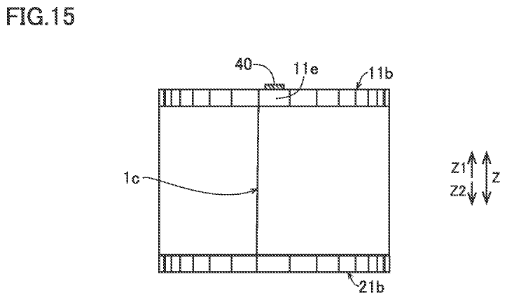

FIG. 13 is a diagram showing a variation of FIG. 12. In the example shown in FIG. 13, the portion 11e is provided only on the outer periphery 1a of the wound electrode assembly 1. Specifically, the portion 11e is provided on the termination portion 1c on the outer periphery 1a. FIG. 14 is a cross-sectional view of the wound electrode assembly 1, taken along XIV-XIV line of FIG. 13.

In the above embodiment, the welded portion 40 is formed on the positive side of the power storage cell 100 and the welded portion 50 is formed on the negative side of the power storage cell 100. However, the present disclosure is not limited thereto. Only one of the welded portion 40 and the welded portion 50 may be formed. FIG. 15 shows an example in which only the welded portion 40 is formed and the welded portion 50 is not formed.

In the above embodiment, the uncoated portions are welded by laser. However, the present disclosure is not limited thereto. The uncoated portions may be welded by a means other than a laser (such as gas welding, soldering, and arc welding).

In the above embodiment, the positive uncoated portion 11b and the negative uncoated portion 21b are bent radially inward. However, the present disclosure is not limited thereto. At least one of the positive uncoated portion 11b and the negative uncoated portion 21b may be bent radially outward.

In the above embodiment, the slit 11g is formed between the positive uncoated portions 11b. However, the present disclosure is not limited thereto. The slit may not be formed between the positive uncoated portions. In other words, the positive current collector may include a single positive uncoated portion wound about the winding axis α. The negative side of the power storage cell 100 may also have the same configuration.

In the above embodiment, the positive uncoated portions 11b, each including the portion 11c and the portion 11d, are provided. However, the present disclosure is not limited thereto. Multiple portions 11d may be connected to a single portion (a portion corresponding to the portion 11c) extending in the winding direction. The negative side of the power storage cell 100 may also have the same configuration.

Note that the embodiment and the respective variations thereof may be combined.

Although the embodiment according to the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell, comprising:
a wound electrode assembly which includes a first electrode, a second electrode, and a separator disposed between the first electrode and the second electrode; and
a case accommodating the wound electrode assembly, wherein
the wound electrode assembly is configured of the first electrode, the second electrode, and the separator being wound about a winding axis,
the first electrode includes a first current collector and a first electrode material layer with which a portion of the first current collector is coated, the first electrode material layer facing the separator in a radial direction of the wound electrode assembly, wherein
the first current collector has:
a first coated portion that is coated with the first electrode material layer; and
a first uncoated portion that is not coated with the first electrode material layer, the first uncoated portion projecting from the first coated portion to one axial side of the wound electrode assembly, wherein
the first uncoated portion is bent in the radial direction, and
the first uncoated portion includes a first portion and a first proximate portion which are joined together by welding, wherein the first proximate portion projects from the first coated portion at a location more proximate to the winding axis than a location at which the first portion projects from the first coated portion.

2. The power storage cell according to claim 1, wherein
a welded portion, which is formed by the first portion and the first proximate portion being welded together, is formed in a portion on the one axial side of the wound electrode assembly.

3. The power storage cell according to claim 2, wherein
the welded portion is formed at least in the first portion on the outer periphery of the wound electrode assembly.

4. The power storage cell according to claim 3, wherein
the wound electrode assembly includes a termination portion where winding of the wound electrode assembly terminates, and
the welded portion is formed at least in the first portion on the termination portion.

5. The power storage cell according to claim 3, wherein
the welded portion extends from the first portion on the outer periphery to the first proximate portion on the inner periphery of the wound electrode assembly.

6. The power storage cell according to claim 1, wherein
the second electrode includes a second current collector and a second electrode material layer with which a portion of the second current collector is coated, the second electrode material layer facing the separator in the radial direction, wherein
the second current collector has:
a second coated portion that is coated with the second electrode material layer; and
a second uncoated portion that is not coated with the second electrode material layer, the second uncoated portion projecting from the second coated portion to the other axial side of the wound electrode assembly, wherein
the second uncoated portion is bent in the radial direction, and
the second uncoated portion includes a second portion and a second proximate portion which are joined together by welding, wherein the second proximate portion projects from the second coated portion at a location more proximate to the winding axis than a location at which the second portion projects from the second coated portion.
